(19) United States
(12) Patent Application Publication
(10) Pub. No.: US 2018/0095720 A1
(43) Pub. Date: Apr. 5, 2018

(54) STORAGE DEVICE WITH FINE GRAINED SEARCH CAPABILITY

(71) Applicant: Intel Corporation, Santa Clara, CA (US)

(72) Inventors: Vinodh GOPAL, Westborough, MA (US); Jawad B. KHAN, Cornelius, OR (US); Sanjeev N. TRIKA, Portland, OR (US)

(21) Appl. No.: 15/282,544

(22) Filed: Sep. 30, 2016

(51) Int. Cl. G06F 7/20; G06F 17/30

(52) U.S. Cl. CPC G06F 7/20; G06F 17/30483; G06F 17/3033

(57) ABSTRACT

A storage device is described. The storage device includes non volatile memory having data storage resources organized into slots to store chunks of data. The storage device includes memory to store a data pointer table having groups of pointers to the slots. Each of the groups correspond to a respective block that is stored in the non volatile memory. Certain ones of the pointers are to have an associated set of hashes of different segments of the respective chunks that are pointed to by the certain ones of the pointers. The storage device includes a search module to implement a search function within the storage device that hashes a search key and compares the hashed search key to the hashes of the different segments to identify a possible match to the search key.

### FIELD OF INVENTION

The field of invention pertains generally to the computing sciences, and, more specifically, to a storage device with fine grained search capability.

### BACKGROUND

Computing systems typically include non volatile mass storage to store sectors or blocks of data and program code. A pertinent issue in many computer systems is the performance of the mass storage. Here, as is understood in the art, a computing system operates by executing program code stored in main memory. Thus, transfers of large amounts of data and program code between main memory and mass storage are part of the normal operation of a computing system as the data and code that are currently needed for software execution are read from mass storage and written into main memory while large amounts of data and program code that are not currently needed for software execution are read from main memory and written into mass storage. Finding ways to improve mass storage performance is therefore a motivation of computing system engineers.

### FIGURES

A better understanding of the present invention can be obtained from the following detailed description in conjunction with the following drawings, in which:

FIG. 1 shows a traditional computing system (prior art);

FIG. 2 shows an improved computing system;

FIG. 3 shows an architecture for an SSD;

FIG. 4 shows a group of pointers;

FIG. 5 shows an SSD implementation;

FIG. 6 shows a method performed by an SSD;

FIG. 7 shows a computing system.

### DETAILED DESCRIPTION

Storing data is a primary application of a computing system. A follow-on application is the ability to search a computing system's stored data for a specific looked for item of data. Here, the computing system may actively store vast amounts of data. Only a few items within the data, however, may include the looked for data. Thus, a search function nominally includes the challenge of filtering through vast amounts of data for specific information that only exists in relatively few of the data items that are stored.

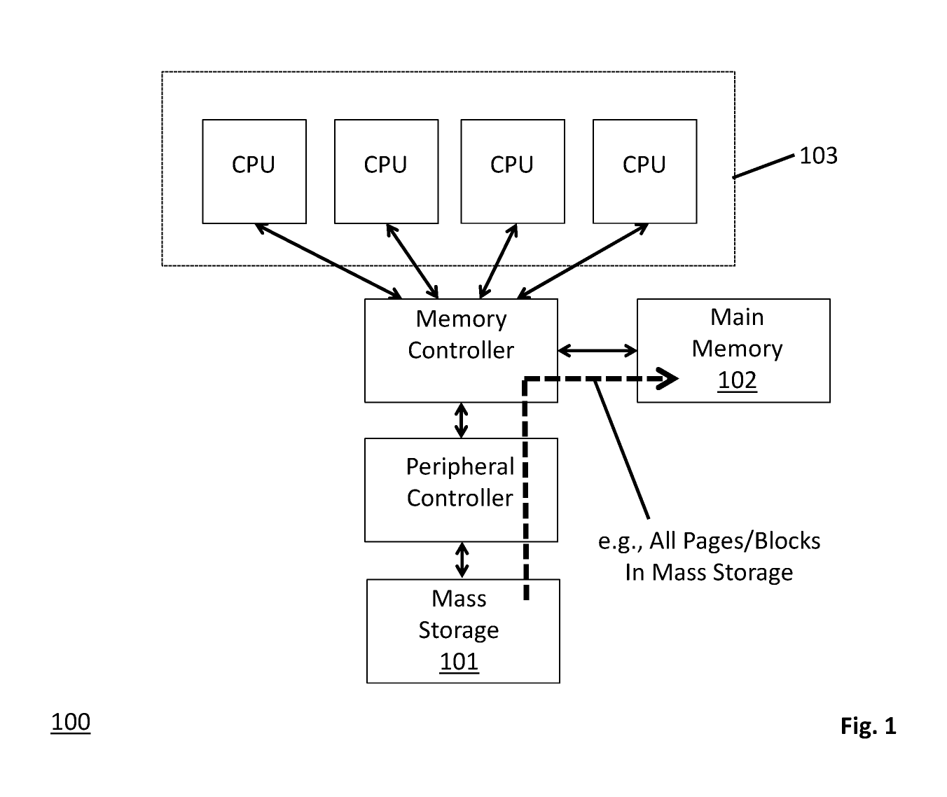

FIG. 1 shows a basic computing system 100 and a traditional data search approach. As observed in FIG. 1, a traditional data search is performed by software were, e.g., pages or blocks of data are called up from mass storage 101 and put into system or main memory 102. Software program code executing on one or more CPU(s) 103 search the content of the pages within system memory 102 and identify a match for any page (or smaller granularity data item on a page) having the searched for data. After the appropriate volume within mass storage 101 has been searched (which may include all pages within mass storage), the search operation is complete.

A traditional search process therefore often entails the moving of vast amounts of data into system memory 102 from mass storage 101 only to identify a small subset of that data as the resultant of the search operation.

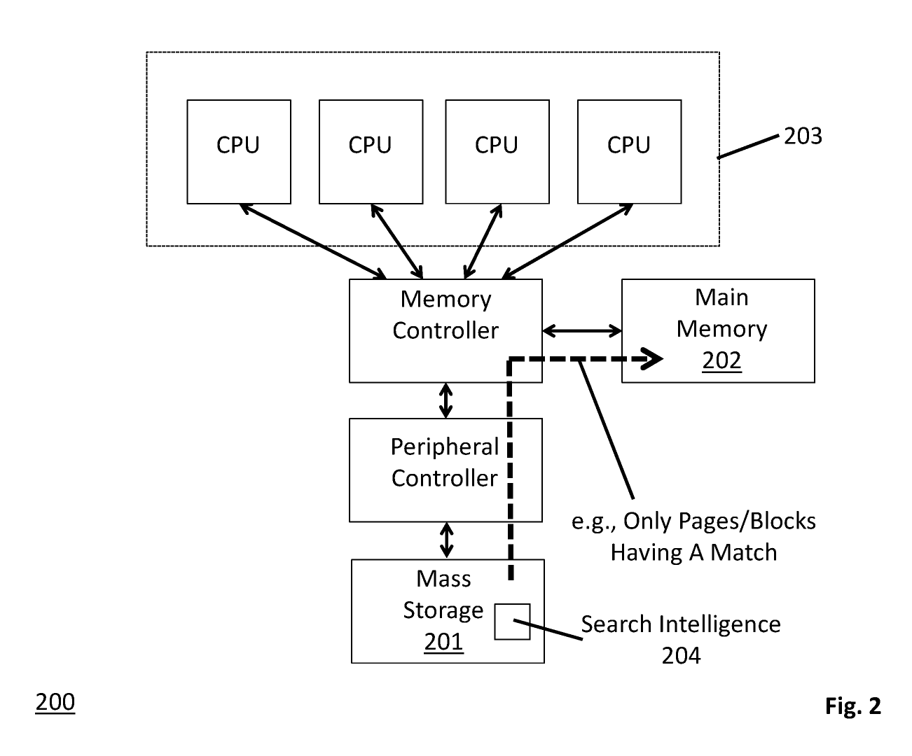

FIG. 2 shows an improved approach in which searching intelligence 204 is embedded into the mass storage device(s) 201. By embedding searching intelligence 204 into the mass storage device(s) 201, the flow of large amounts of information from mass storage 201 into system memory 202 can be avoided. The search intelligence 204 may be implemented as a search module composed, e.g., of hardware and/or software within a mass storage device.

As is known in the art, solid state drive (SSD) devices are becoming increasingly popular mass storage devices. Whereas mass storage devices have traditionally been implemented with hard disk drives that rotated magnetic disks and stored data on large sectors or tracks which approximately corresponded to one or more revolutions of the disk, by contrast, SSD devices use non volatile memory semiconductor chips as the physical storage medium. Without the hindrance of rotating disks, SSD devices have the potential to implement more sophisticated read/write processes, such as, search routines including fine granularity search routines as described more thoroughly immediately below.

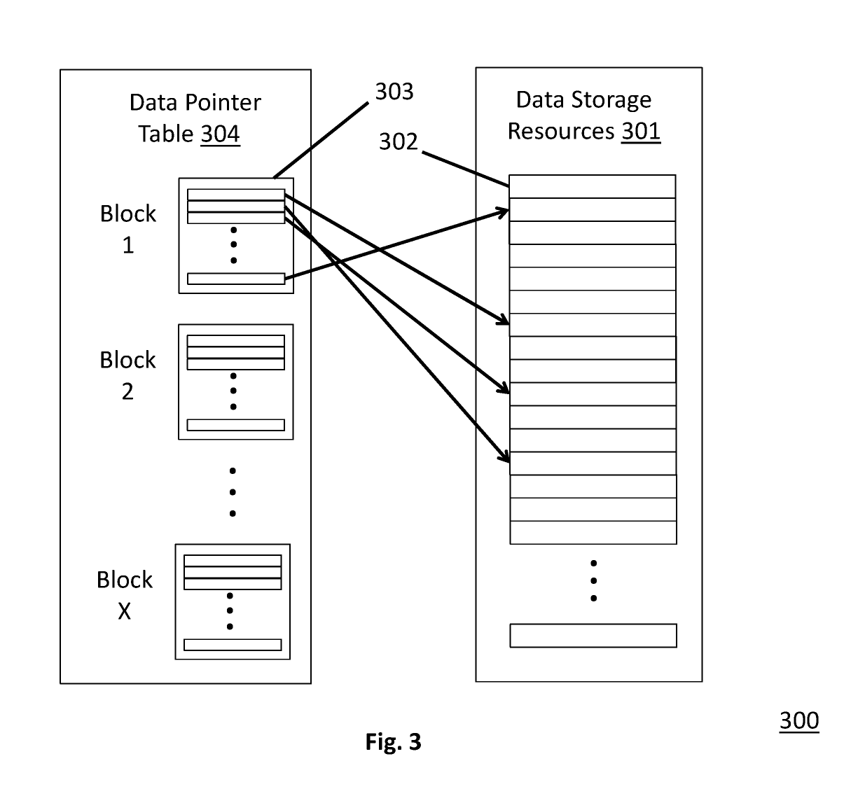

FIG. 3 shows an embodiment of an logical storage approach 300 that may be implemented within a storage device such as an SSD device. As observed in FIG. 3, for the sake of example, the SSD device is designed to store 4 kilobyte (kB) blocks or pages of information. A 4 kB block of data can be viewed as being broken down into sixty four 64 byte (B) chunks of data (64×64 B=4096 B).

The data storage resources 301 of the non volatile memory (NVM) chips within the SSD 300 are logically implemented akin to a cache having a large number of slots 302 each capable of storing a 64 B chunk of data (for ease of drawing only one of the slots is actually labeled in FIG. 3). A block of data that is stored in the non-volatile memory in the SSD is represented as a list/group of pointers 303 within a data pointer table (DPT) 304 where each pointer in the group 303 point to one of the slots in the data storage resources 301 (for ease of drawing only one group of pointers is actually labeled in FIG. 3).

Thus, for any block that is represented in the DPT 304 (and therefore deemed stored in the SSD device), there is one pointer into the data storage resources 301 for each 64 B chunk in the block. In the case of a 4 kB block that is represented in the DPT 304, there are 64 pointers in the group of pointers 303 within the DPT for that block (each of which point into a respective slot within the data storage resources 301 (64 pointers×64 B per chunk=4096 B=4 kB)).

The contents of the DPT (which will nominally include multiple groups of pointers representing simultaneous storage of multiple blocks in the SSD), in various embodiments, is also stored in the storage space of one or more non volatile memory chips of the SSD device. Thus, the storage space of the SSD device's non volatile memory chips can largely be viewed as having some space reserved for the DPT 304 and a remaining portion that corresponds to the data storage resources 301 which have been organized into a number of slots.

When updating the DPT 304 to reflect the writing of a block of data into the SSD, the contents of each 64 B chunk of the block are hashed within the SSD device. The hashing operation, for each chunk, generates a hash digest that points to a plurality of different slots in the data storage resources 301 for that chunk. Here, chunks of different data content will generally produce respective hash digests that point to a different group of slots in the data storage resources 301. The contents of the slots that are pointed to by the hash digest of a particular chunk to be written are read from the data storage resources 301 and compared to the contents of the particular write chunk.

If the content of a chunk read from one of the storage resource slots matches the content of the chunk to be written, a reference counter in meta data for the matching chunk's slot is incremented (the counter essentially counts how many chunks having the slot's content are stored in the SSD device) and a pointer that points to that slot is listed in the DPT 304 for the write chunk. The pointer is associated with the group of pointers in the DPT 304 for the chunk's corresponding block. Note that incrementing a slot's counter upon a match being found in the slot's chunk, rather than actually writing into the data storage resources 301 the chunk of the block being written, corresponds to a deduplication (dedup) storage process/implementation within the SSD. If the reference counter for a slot reaches zero, the slot is deemed free to be written over with different data of a forthcoming chunk whose data value does not match the content of any slots that is hash digest identified (the slot is deemed empty). When a block is erased from the NVM in the SSD, each of the block's pointers in the DPT 304 are referenced to access their corresponding slot and decrement its associated counter.

Returning to a discussion of the write process for a block of information, if none of the chunks that were read from the data storage resources 301 match the write chunk's content, the write chunk's content is written into an empty one of the slots in the data storage resources 301 that is pointed to by the write chunk's hash digest. The counter for the slot is incremented to 1 to indicate there is one chunk stored in the SSD NVM having the content of the write chunk. A pointer to the newly filled slot is entered into the DPT 304 and associated/grouped in the DPT 304 with the respective pointers of the other chunks of the block being written.

Upon entering a pointer for a chunk into the DPT 304 the chunk is deemed written into the SSD device. When all chunks for a block have pointers entered in the DPT 304 the block is deemed written into the SSD. Again, in the case of a 4 kB block broken down into sixty four 64 B chunks, the group 303 of pointers for the block contains 64 pointers each of which point to a particular slot within the data storage resources 301. In an embodiment, the pointers are listed in the group 303 in order. That is, the pointer for the first chunk in the block is listed first in the group, the pointer for the second chunk in the block is listed second in the group, etc. The block has a logical block address (LBA) which is associated with the group of pointers for the block in the DPT. In various embodiments, the LBA is used by the host system to identify the block specifically.

Upon a read request being received by the SSD device 300, the LBA for the block is used to identify the group of pointers 303 for the block within the DPT 304. The pointers within the identified group of pointers 303 are then used to fetch the corresponding chunks of data from the data storage resources 301 with the order of the pointers being preserved or otherwise accounted for so that the read data chunks can be assembled correctly in order by the SSD device 300 prior to forwarding the reconstructed block to the requesting entity.

In order to support search functions within the SSD device 300 itself, in various embodiments, the size of the pointers is made larger than is needed to reference all of the slots in the storage resources 301. For example, in one embodiment, the pointers are designed to be data structures having a size of 64 bits each. Here, a 64 bit pointer corresponds to an addressing capability of 1.844×10¹⁹ different slots in the data storage resources 301. As the data storage resources 301 of the SSD would not have a storage capacity that corresponds to that many slots, the pointer size of 64 bits is by design “overkill” given the SSD device's actual storage capacity. Currently, the largest capacity SSD devices would need pointer values of less than 50 bits to adequately point to a number of slots that correspond to the full storage capacity of the SSD device.

With each pointer deliberately allocated an overly large bit size, the excess pointer capacity can be used to keep values that are representative of the actual data that a pointer points to. With the pointer keeping within itself content that is representative of the data being pointed to, a pointer, rather than its corresponding data value in the data storage resources 301, can be searched through by the SSD's search module in order to economize the SSD's computational overhead needed to perform a search function. That is, the search function can be performed by the search module searching substantially through the DPT 304 rather than the data storage resources 301 which lessens the computation burden of the overall search.

Further still, as will be described in more detail further below, a pointer value can be compressed so as to provide even more space for keeping information that is representative of the data value being pointed to. By so doing, the excess space becomes sufficiently large to store a set of values that are representative of different segments of the chunk that is pointed to. With each element of the set corresponding to a different segment of a chunk, the elements themselves can be individually searched to effectively support search functions with search key sizes that are smaller than the chunk size. That is, the SSD can perform fine grained searches.

Here, various database applications are interested in finding data that matches to a smaller looked for data value (search key) than the size of the data chunk itself. For example, various database applications may desire to search for values in a block that are less than 22 B such as 16 B. Here, each element in the set of values kept in the DPT space for a particular pointer could correspond to a different 16 B segment of the 64 B chunk that the pointer points to. By so doing, the SSD search module could perform, e.g., aligned 16 B searches on its 64 B chunks.

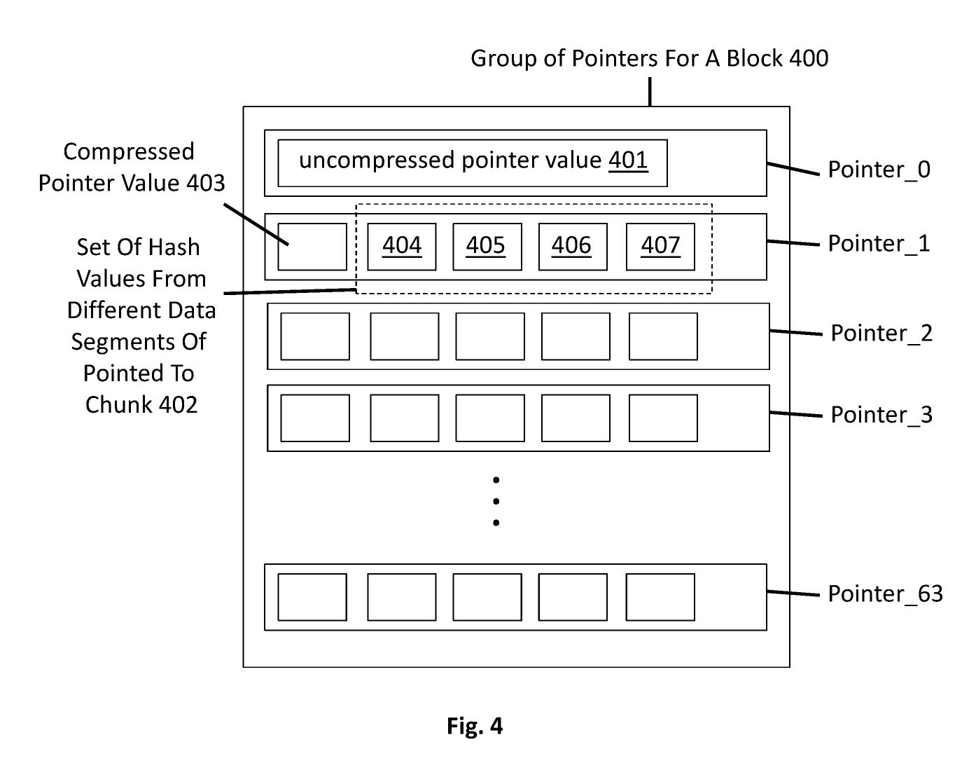

FIG. 4 shows an embodiment of a group of pointers 400 for a particular block. Here, as observed in FIG. 4, the group of pointers 400 includes a first nominal pointer (Pointer_0) having a full (uncompressed) pointer value 401. The remainder of the pointer values in the group 400, to the extent possible, are compressed in order to “make room” for a set of four elements 402 (per pointer having a compressed pointer value) that correspond to different 16 B segments within a 64 B data chunks that is pointed to. The compression of the pointer value, in an embodiment, is expressed as an offset from the first nominal pointer 401. That is, for example, if the first nominal pointer 401 has a value of A and the pointer value for the second pointer (Pointer_1) has a value of A+X, then, the compressed pointer value 403 for Pointer_1 is only+X (both a sign term (+) and an offset term (X)).

In order to reconstruct the address of the slot that Pointer_1 points to, the SSD uses the first nominal pointer value (A) and applies the compressed value 403 (+X) within Pointer_1 to calculate A+X as the address for Pointer_1. As such, each compressed pointer value is expressed as an absolute offset value term and a directional or sign term offset (compressed pointer values for addresses that are less than the first nominal pointer value 401 have a negative (−) sign term). Generally, there is some expectation that the various pointer values within the group of pointers 400 for a block will be numerically proximate to the first nominal pointer value 401 that the base-delta approach described herein can sufficiently compress many of the pointer values to a value well below 32 bits (note that size of the compressed pointer value can vary from pointer to pointer).

For those pointer values that can be compressed below 32 bits, there will be more than 32 bits of space remaining in the 64 bit space that has been allocated for the pointer. For those pointers that can free up 32 bits in this manner, the extra space is used to store the aforementioned set of four of values 402 that respectively correspond to the four different 16 B segments within the 64 B chunk that is pointed to. For example, in one embodiment, a first 8 bit value 404 that is kept in the extra pointer space corresponds to the 64 B chunk's first 16 B segment, a second 8 bit value 405 that is kept in the extra pointer space corresponds to the 64 B chunk's second 16 B segment, a third 8 bit value 406 that is kept in the extra pointer space corresponds to the 64 B chunk's third 16 B segment, and a fourth 8 bit value 407 that is kept in the extra pointer space corresponds to the 64 B chunk's fourth 16 B segment.

The different 8 bit values 404 through 407, in an embodiment, are calculated as hashes on the respective 16 B segments of the 64 B chunk that is pointed to. That is, during the writing of the chunk as part of the initial writing of the chunk's block into the SSD, assuming that the slot the chunk has been assigned to corresponds to a pointer value that can be compressed so as to free up excess pointer space for the keeping of the set of four hash values 402, the first 16 B segment of the chunk is hashed to produce the first 8 bit element 404 that is stored in the excess pointer space, the second 16 B segment of the chunk is hashed to produce the second 8 bit element 405 that is stored in the excess pointer space, the third 16 B segment of the chunk is hashed to produce the third 8 bit element 406 that is stored in the excess pointer space, and the fourth 16 B segment of the chunk is hashed to produce the fourth 8 bit element 407 that is stored in the excess pointer space.

All pointers in the group 400 having a pointer value that is numerically proximate to the first nominal pointer value such that the compression of the pointer value will support the addition of the four 8 bit elements 402 (i.e., free up at least 32 bits) have their pointer values accordingly compressed and the extra allocated space is used to keep the set of four 8 bit elements 402. Those pointers in the group having a pointer value that cannot be compressed so as to free up 32 bits are not compressed (their full value is kept in their allocated storage space). For ease of drawing FIG. 4 only shows the nominal first pointer, Pointer_0 as containing an uncompressed pointer value 401.

When a group of pointers 400 is structured as described just above, the compressed pointer entries provide for reduced overhead searching including fine grained searches. More specifically, the set of four 8 bit values 402 can be used to support a “coarse” search for search keys as small as 16 B.

Here, a search function is initiated by the requesting entity such as a host system providing a search key to the SSD which is provided to the SSD's search module. For a search key of only 16 B, the search module performs a hash on the 16 B search key and if the 8 bit value generated from the hash on the search key matches any of the 8 bit values 404 through 407 in a pointer entry there is some probability that the contents of the chunk that the pointer points to has a matching segment. When there is match between the hash of the search key and one of the 8 bit values 404 through 407 in the pointer entry, the the search module fetches the 64 B chunk that is pointed to (or just the implicated segment) from the data storage resources 301 to confirm whether or not the stored chunk actually matches the search key. If so, the block that the pointer/chunk belongs to is tagged by the search module as a match and the search module moves the search process on to the next group of pointers in the DPT 304 to search a next block that is stored by the SSD.

Importantly, when none of the four 8 bit values 404 through 407 within a pointer entry match the value generated by the hash on the search key then it is known that the 64 B data chunk that is pointed to by the pointer does not contain a matching value. Thus, the performance hit of having to fetch the 64 B chunk from the storage resources 301 only to observe a miss is avoided. Said another way, the presence of the 8 bit values 404 through 407 in the compressed pointer value entries enables the SSD's search module to quickly skip over those pointed to chunks (i.e., not actually read them from the data storage resources 301) that do not contain a matching value. Instead, only those pointed to chunks that have some probability of containing the looked for value are actually fetched from the data storage resources 301 by the SSD's search module.

In this manner, the search process is more efficient because chunks whose numerical data content is not sufficiently near the looked for value has hashed values 404 through 407 in its pointer entry that will not match the hash on the search key and the search process can move on to a next pointer entry while keeping its internal processing within the DPT 304. Those pointer values that are not compressed will have their pointed to chunks physically read from the data storage resources 301 by the search process. If a respectable percentage of the pointer entries within the DPT 304 are compressed, then, a measureable efficiency improvement in the overall search performed by the SSD's search module should be realized. Pointer entries may also be structured to reserve one bit that indicates whether its content contains a compressed pointer value or an uncompressed pointer value.

The pointer structure described above also can be used to support searches on larger keys. For example, the case of a 32 B search key, first and second 16 B segments of the search key are hashed to produce two 8 bit values. If any neighboring pair of the 8 bit values 404 through 407 in a pointer entry match the two 8 bit values generated from the hash on the key then the data of the pointed to chunk is fetched from the data storage resources and compared to the actual search key to confirm/deny the existence of an actual match (i.e., the pointed to chunk has some probability of being a match). If a compressed pointer entry does not contain a neighboring pair of 8 bit values that match the pair of 8 bit values generated from the search key then the pointer points to a chunk whose data value does not match the search key and the chunk is not fetched from the data storage resources.

Ina similar manner 48 B and 64 B search keys can also be supported. In the case of a 48 B search key, three different 16 B segments of the search key are hashed to generate three 8 bit values. A potential match exists for any pointer having a neighboring group of three 8 bit values that match the three 8 bit values generated from the key. In the case of a 64 B search key, four 8 bit values are generated from four 16 B segments of the search key. A possible match exists for any pointer entry whose set of four 8 bit values match the four 8 bit values generated from the hashes performed on the search key segments.

In various other embodiments, the base pointer value 401 that the compressed pointer values reference within a group 400 may be other than the first pointer value in a group. For instance, the set of pointer values for a group may be analyzed by the SSD's search module and a pointer address within the group that is closest to a midpoint, average or minimum average distance from other pointer values in the group may be chosen as the base pointer for the group so that an approximately maximum number of pointer entries for the group are compressed and a minimum number of pointer entries for the group are not compressed. In still other embodiments, the pointers of multiple groups may reference a same base value including a base value deemed to be, e.g., from analysis of the pointer values in the DPT 304, at a midpoint, average or minimum average distance from other pointer values within the DPT 304.

In an embodiment, after all groups of pointer entries in the DPT 304 have been analyzed as described above, the logical block address of those blocks that were tagged as having a match are returned to the requesting entity as the search result and/or the SSD begins to read out and forward the matching blocks to system memory or the requesting entity. In an alternate embodiment, the meta data in the storage resources are expanded to not only identify how many pointers point to them, but also, which blocks are pointing to them. In this case, for any unique match to the search key, the set of blocks that contain the unique match can be immediately identified upon the first read of the chunk to confirm the match.

The technology of the non volatile memory chips in the SSD device may vary from embodiment to embodiment. In various embodiments the non volatile memory chips may have storage cells stacked in three dimensions monolithically integrated on the same semiconductor die and have a three dimensional crosspoint architecture. In various embodiments the storage cells may be composed of an emerging non volatile memory technology such as, to name a few possibilities, phase change storage cells, storage cells composed of chalcogenide, ferro-electric storage cells (e.g., FRAM), magnetic storage cells (e.g., MRAM), spin transfer torque storage cells (e.g., STT-RAM), resistive storage cells (e.g., ReRAM), Memristor storage cells, universal memory storage cells, Ge2Sb2Te5 storage cells, programmable metallization cell memory storage cells, amorphous cell memory storage cells, Ovshinsky memory storage cells, etc. Such emerging non volatile memory technologies can have finer grained accesses for writing/erasing than traditional FLASH memory storage cells and, unlike traditional FLASH, provide for write-in-place functionality which may provide for easier implementation of data storage resources organized into (e.g., 64 B) slots as described at length above.

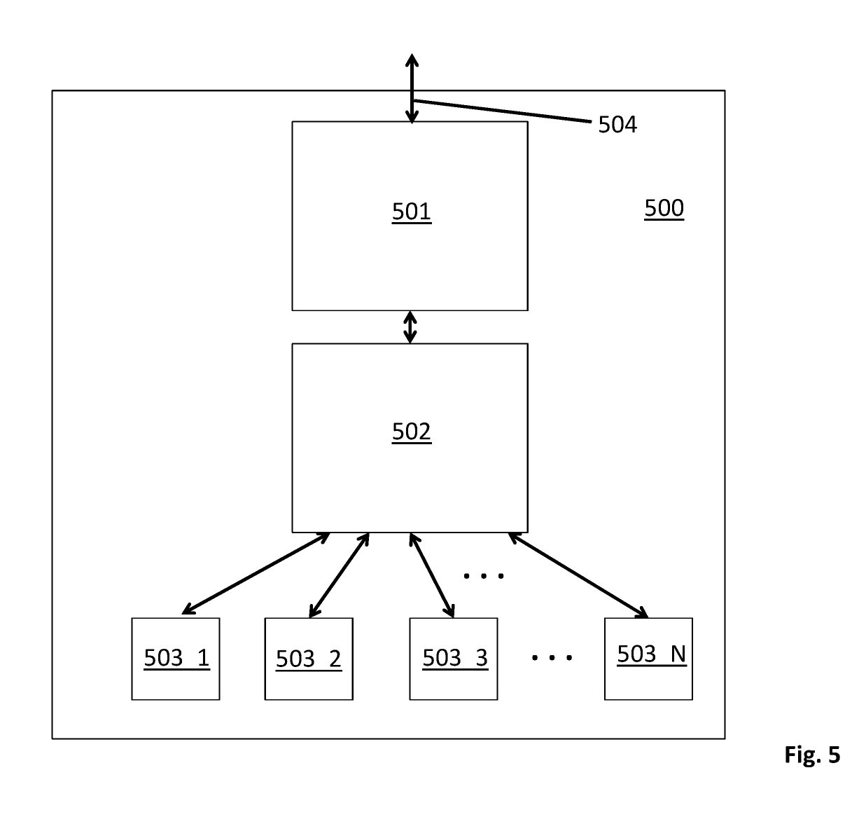

FIG. 5 shows an embodiment of an SSD 500 that is designed to incorporate the architecture and functionality described above. As observed in FIG. 5, the SSD 500 includes a control function 501 that implements the functions and operations performed by the SSD. Here, the control function 501 may be implemented with a controller or processor that executes firmware program code, dedicated hardware logic circuitry (e.g., hardwired or programmable (e.g., Field Programmable Gate Array (FPGA), programmable logic device (PLD), programmable logic array (PLA))), or, a combination of program code and hardware logic circuitry. Any program code that is executed by the control function may be locally stored in non volatile storage resources of the SSD. In various embodiments, the aforementioned search module is a component of the control function 501.

The SSD 500 also includes a plurality of non volatile semiconductor chips 503_1 through 503_N and buffer and arbitration circuitry 502 to queue and process actual read/write traffic with the storage devices 503_1 through 503_N. The SSD also includes a host interface such as a peripheral component interface express (PCIe) link, a Non-Volatile Memory Express (NVMe) link, a Remote Direct Memory Access (RDMA) interface, a Fibre Channell interface or other form of interconnect. Although the DPT as described above can be implemented in one or more of the non volatile storage devices 503_1 through 503_N, in various other embodiments, at least a copy of the DPT may be stored in faster volatile memory (e.g., DRAM) utilized by the control function 501 to speed up the operations of the control function in the SSD including reads, writes, hashes and searches. In still yet other embodiments, the DPT table information may be kept in a content addressable memory (CAM) to support native search capability directly in the hardware (matching hash values in the DPT entries are identified directly by the hardware).

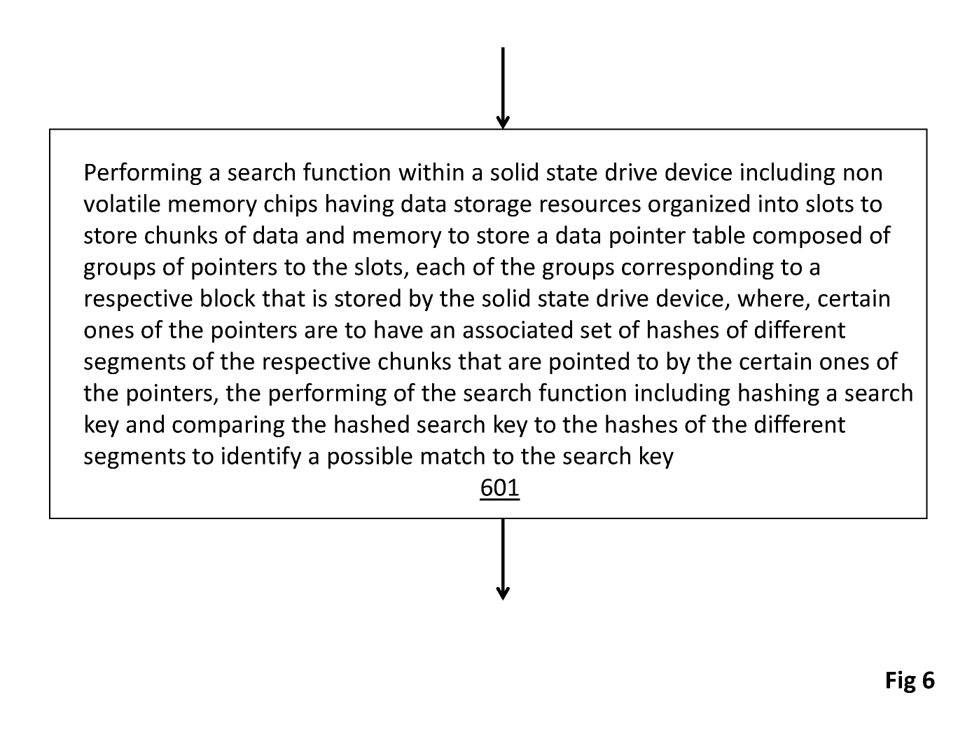

FIG. 6 depicts a methodology 601 for performing a search function within a solid state drive device including non volatile memory chips having data storage resources organized into slots to store chunks of data and memory to store a data pointer table composed of groups of pointers to the slots. Each of the groups correspond to a respective block that is stored by the solid state drive device. Certain ones of the pointers are to have an associated set of hashes of different segments of the respective chunks that are pointed to by the certain ones of the pointers. The performing of the search function includes hashing a search key and comparing the hashed search key to the hashes of the different segments to identify a possible match to the search key.

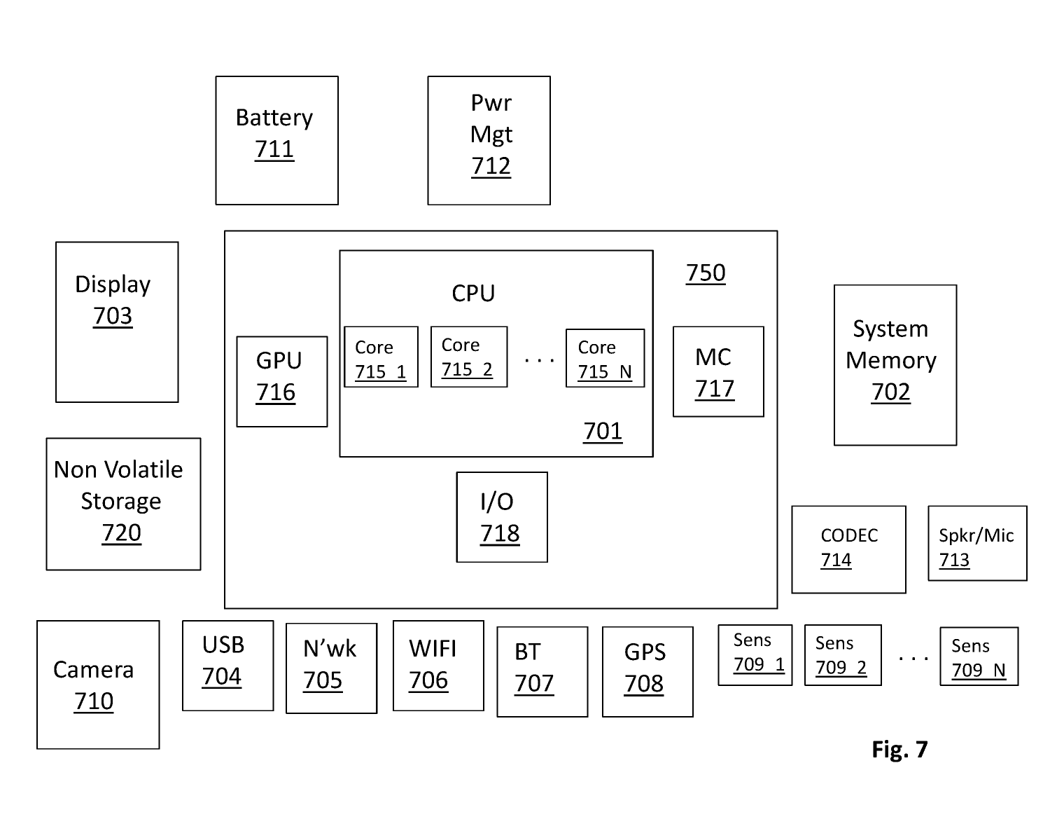

FIG. 7 shows a depiction of an exemplary computing system 700 such as a personal computing system (e.g., desktop or laptop) or a mobile or handheld computing system such as a tablet device or smartphone, or, a larger computing system such as a server computing system. As observed in FIG. 7, the basic computing system may include a central processing unit 701 (which may include, e.g., a plurality of general purpose processing cores and a main memory controller disposed on an applications processor or multi-core processor), system memory 702, a display 703 (e.g., touchscreen, flat-panel), a local wired point-to-point link (e.g., USB) interface 704, various network I/O functions 705 (such as an Ethernet interface and/or cellular modem subsystem), a wireless local area network (e.g., WiFi) interface 706, a wireless point-to-point link (e.g., Bluetooth) interface 707 and a Global Positioning System interface 708, various sensors 709_1 through 709_N (e.g., one or more of a gyroscope, an accelerometer, a magnetometer, a temperature sensor, a pressure sensor, a humidity sensor, etc.), a camera 710, a battery 711, a power management control unit 712, a speaker and microphone 713 and an audio coder/decoder 714.

An applications processor or multi-core processor 750 may include one or more general purpose processing cores 715 within its CPU 701, one or more graphical processing units 716, a memory management function 717 (e.g., a memory controller) and an I/O control function 718. The general purpose processing cores 715 typically execute the operating system and application software of the computing system. The graphics processing units 716 typically execute graphics intensive functions to, e.g., generate graphics information that is presented on the display 703. The memory control function 717 interfaces with the system memory 702. The system memory 702 may be a multi-level system memory such as the multi-level system memory discussed at length above.

Each of the touchscreen display 703, the communication interfaces 704-707, the GPS interface 708, the sensors 709, the camera 710, and the speaker/microphone codec 713, 714 all can be viewed as various forms of I/O (input and/or output) relative to the overall computing system including, where appropriate, an integrated peripheral device as well (e.g., the camera 710). Depending on implementation, various ones of these I/O components may be integrated on the applications processor/multi-core processor 750 or may be located off the die or outside the package of the applications processor/multi-core processor 750.

The mass storage of the computing system may be implemented with non volatile storage 720 which may be coupled to the I/O controller 718 (which may also be referred to as a peripheral control hub). The mass storage may be implemented with one or more SSDs having the architecture and search functionality described above.

Embodiments of the invention may include various processes as set forth above. The processes may be embodied in machine-executable instructions. The instructions can be used to cause a general-purpose or special-purpose processor to perform certain processes. Alternatively, these processes may be performed by specific hardware components that contain hardwired logic for performing the processes, or by any combination of software or instruction programmed computer components or custom hardware components, such as application specific integrated circuits (ASIC), programmable logic devices (PLD), digital signal processors (DSP), or field programmable gate array (FPGA).

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus comprising:
a storage device, comprising:
non volatile memory having data storage resources organized into slots to store chunks of data;
memory to store a data pointer table comprised of groups of pointers to the slots, each of the groups corresponding to a respective block stored in the non-volatile memory, where, certain ones of the pointers are to have an associated set of hashes of different segments of the respective chunks that are pointed to by the certain ones of the pointers;
a search module to implement a search function within the storage device that hashes a search key and compares the hashed search key to the hashes of the different segments to identify a possible match to the search key.

2. The apparatus of claim 1 wherein the search function is to read a chunk pointed to by a pointer having a hash of the chunk that matches the hash of the search key and compares the chunk to the search key.

3. The apparatus of claim 1 wherein the certain ones of the pointers are compressed pointer values.

4. The apparatus of claim 1 wherein the search function analyzes pointers of all of the groups of pointers in the data pointer table.

5. The apparatus of claim 1 wherein the search key is able to be smaller than a size of the chunks.

6. The apparatus of claim 1 wherein the search key is able to be less than 22 bytes.

7. The apparatus of claim 1 wherein entries in the data pointer table for respective pointers have a bit size, the bit size corresponding to a storage capacity that is greater than the storage device's storage capacity if utilized as an address into the data storage resources.

8. A computing system, comprising:
a plurality of processing cores;
a main memory controller;
a main memory coupled to the main memory controller;
a peripheral control hub;
a solid state drive coupled to the peripheral control hub, the solid state drive comprising:
non volatile memory chips having data storage resources organized into slots to store chunks of data;
memory to store a data pointer table comprised of groups of pointers to the slots, each of the groups corresponding to a respective block that is stored by the solid state drive device, where, certain ones of the pointers are to have an associated set of hashes of different segments of the respective chunks that are pointed to by the certain ones of the pointers;
a search module to implement a search function within the SSD that hashes a search key and compares the hashed search key to the hashes of the different segments to identify a possible match to the search key.

9. The apparatus of claim 8 wherein the search function is to read a chunk pointed to by a pointer having a hash of the chunk that matches the hash of the search key and compares the chunk to the search key.

10. The apparatus of claim 8 wherein the certain ones of the pointers are compressed pointer values.

11. The apparatus of claim 8 wherein the search function analyzes pointers of all of the groups of pointers in the data pointer table.

12. The apparatus of claim 8 wherein the search key is able to be smaller than a size of the chunks.

13. The apparatus of claim 8 wherein the search key is able to be less than 22 bytes.

14. The apparatus of claim 8 wherein entries in the data pointer table for respective pointers have a bit size, the bit size corresponding to a storage capacity that is greater than the solid state drive device's storage capacity if utilized as an address into the data storage resources.

15. A method, comprising:
performing a search function within a solid state drive device comprising non volatile memory chips having data storage resources organized into slots to store chunks of data and memory to store a data pointer table comprised of groups of pointers to the slots, each of the groups corresponding to a respective block that is stored by the solid state drive device, where, certain ones of the pointers are to have an associated set of hashes of different segments of the respective chunks that are pointed to by the certain ones of the pointers, the performing of the search function comprising:
hashing a search key and comparing the hashed search key to the hashes of the different segments to identify a possible match to the search key; and,
fetching content of a slot of the data storage resources pointed to by a pointer having a hashed segment that matches the hash of the search key to confirm whether a match to the search key exists.

16. The method of claim 15 wherein the search key size is smaller than a chunk size.

17. The method of claim 16 wherein the search key size is less than 22 B.

18. The method of claim 17 wherein the search key size is 16 B.

19. The method of claim 15 wherein certain ones of the pointers are compressed pointer values.

20. The method of claim 15 further comprising analyzing pointers of all of the groups of pointers in the data pointer table.

21. A machine readable storage medium containing program code that when processed by a control function of a solid state drive device causes the solid state drive device to perform a search function, wherein the solid state drive device comprises non volatile memory chips having data storage resources organized into slots to store chunks of data and memory to store a data pointer table comprised of groups of pointers to the slots, each of the groups corresponding to a respective block that is stored by the solid state drive device, where, certain ones of the pointers are to have an associated set of hashes of different segments of the respective chunk that are pointed to by the certain ones of the pointers, the performing of the search function comprising:
hashing a search key and comparing the hashed search key to the hashes of the different segments to identify a possible match to the search key;
fetching content of a slot of the data storage resources pointed to by a pointer having a hashed segment that matches the hash of the search key to confirm whether a match to the search key exists.

22. The machine readable medium of claim 21 wherein the search key size is smaller than a chunk size.

23. The machine readable medium of claim 22 wherein the search key size is less than 22 B.

24. The machine readable medium of claim 23 wherein the search key size is 16 B.

25. The machine readable medium of claim 21 wherein certain ones of the pointers are compressed pointer values.
